(19) United States
(12) Patent Application Publication
(10) Pub. No.: US 2007/0230816 A1
(43) Pub. Date: Oct. 4, 2007

(54) Image processing device, image processing method, and image processing program product

(76) Inventor: Kenichi Usui, Kagoshima-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/731,450

(22) Filed: Mar. 30, 2007

(30) Foreign Application Priority Data
Mar. 31, 2006 (JP) P2006-096422

(51) Int. Cl. G06K 9/40

(52) U.S. Cl. 382/264

(57) ABSTRACT

A first setting section is operable to set a reference region in a first digital image. A calculating section is operable to calculate first pixel values of pixels in the reference region and second pixel values of the pixels in the reference region on which an averaging process which substantially averages the first pixel values is performed. A creating section is operable to create unevenness-feeling information indicating an unevenness feeling of the surface of an object expressed by the reference region on the basis of the first pixel values and the second pixel values. A second setting section is operable to set a target region in a second digital image. A giving section is operable to give the unevenness feeling to the target region on the basis of the unevenness-feeling information.

The disclosure of Japanese Patent Application No. 2006-096422 filed Mar. 31, 2006 including specification, drawings and claims is incorporated herein by reference in its entirety.

### BACKGROUND

The present invention relates to an image processing device, an image processing method, and an image processing program product.

An related-art image processing device is capable of keeping a color and saturation and acquiring a synthesized image of a texture without a large variation in lightness of a whole image after a synthesis (for example, see Japanese Patent Publication No. 6-86045 A). In the related-art image processing device described in the Japanese Patent Publication No. 6-86045 A, a mean value and a gain value are acquired from overall texture image data, and image data synthesizes a texture image by multiplying a difference between the texture image data and the mean value by the gain value.

By the way, on a digital image, sometimes a dust, a spot, or the like (hereinafter, it will be simply referred to as ‘a dust’) which is attached to a digital still camera or an image scanner which creates the digital image has its picture taken altogether. On the digital image, when an averaging process for substantially averaging pixel values of a region which the dust is taken is performed, it is possible to allow the dust to be invisible. However, when the averaging process is performed, the dust becomes invisible, and on the contrary, an unevenness feeling of the region where an object is taken is impaired. In this case, by giving the same unevenness feeling to the region where the averaging process is performed as the unevenness feeling of the object, it is possible to recover the unevenness feeling of the object.

However, according to the related-art image processing device described in the Japanese Patent Publication No. 6-86045 A, the texture image data is synthesized with the overall image data, and thus there is a problem that the texture image data is synthesized with not only a region where the unevenness feeling is willing to be given but also the other regions.

Additionally, according to the related-art image processing device described in the Japanese Patent Publication No. 6-86045 A, since the mean value and the gain value are acquired from the overall texture image data, thus there is a problem that the mean value and the gain value can not be acquired on the basis of a portion of the region of the texture image data.

### SUMMARY

It is therefore an object of the invention to provide an image processing device, an image processing method, and an image processing program which creates unevenness-feeling information displaying an unevenness feeling of an object based on a random region on a digital image and gives the unevenness feeling to the random region on the digital image based on the created unevenness-feeling information.

In order to achieve the above-mentioned object, according to an aspect of the invention, there is provided an image processing method comprising:

setting a reference region in a first digital image;

calculating first pixel values of pixels in the reference region and second pixel values of the pixels in the reference region on which an averaging process which substantially averages the first pixel values in performed;

creating unevenness-feeling information indicating the unevenness feeling of the surface of an object expressed by the reference region on the basis of the first pixel values and the second pixel values;

setting a target region in a second digital image; and

giving the unevenness feeling to the target region on the basis of the unevenness-feeling information.

With this configuration, it is possible to set an optional region in the first digital image as the reference region, thereby creating the unevenness feeling information which indicates the unevenness feeling of the object on the basis of the optional region in the first digital image. In addition, it is possible to set an optional region in the second digital image as the target region, thereby giving the unevenness feeling to the optional region on the basis of the created unevenness-feeling information.

The image processing method may further comprise:

performing the averaging process on the target region,
wherein the unevenness feeling is given to the target region on which the averaging process is performed.

With this configuration, in a case where the dust is taken in the second digital image, the region where the dust is included is set as the target region, and it is possible to make the dust invisible in the second digital image by performing an averaging process on the set target region. However, the unevenness feeling of which the target region indicates is impaired by performing the averaging process. In this case, the reference region is set in the range of indicating the object of the first digital image where the same or the same kind object is taken and the unevenness-feeling information is created. By the use of giving the unevenness feeling to the target region on the basis of the created unevenness feeling information, it is possible to give the substantially original unevenness feeling to the object of which the target region indicates. That is to say, it is possible to remove the dust without impairing the unevenness feeling of the object.

The averaging process may make a digital image blurred.

With this configuration, it is possible to substantially average the pixel values by performing the process which enables to be blurred.

The unevenness-feeling information may be a set of ratios which are obtained by dividing each of the first pixel values of the pixels by each of the second pixel values of the corresponding pixels.

The unevenness feeling may be given by multiplying third pixel values of pixels in the target region by the ratios.

The image processing method may further comprise setting a size or a shape of the target region.

With this configuration, it is possible to set the size of the shape of the target region, thereby reducing that the unevenness feeling is given to an unnecessary region.

The image processing method may further comprise:

replicating the target region to create a target-region image; and

synthesizing the target-region image with the target region to which the unevenness feeling is given at a predetermined synthesis ratio.

With this configuration, it is possible to alleviate the variation of the unevenness feeling by allowing a region where the unevenness feeling is given to synthesize the target-region image, and thus the person hardly feels or recognizes an incompatibility about the unevenness feeling of the target region.

The target region may have a shape which can specify a center.

The synthesis ratio may indicate in the unit of pixels a ratio of the target region to which the unevenness feeling is given.

The ratio may become lower as a pixel becomes more distant from the center of the target region.

With this configuration, as the pixel becomes distant from the center of the target region, the synthesis ratio of the target region on which the unevenness feeling is performed becomes smaller. In other words, as the pixel becomes distant from the center of the target region, the synthesis ratio of the target region becomes larger. Accordingly, the unevenness feeling of the target region and the unevenness feeling of a peripheral region can be smoothly connected. Thus, it is possible to reduce an unnatural look of a variation of the unevenness feeling of a boundary between the target region and the peripheral region when the person sees them.

The image processing method may further comprise setting the synthesis ratio.

With this configuration, the user can set the desired synthesis ratio.

The first digital image and the second digital image may be the same digital image as each other.

The first digital image and the second digital image may be a digital image which is expressed by an RGB color matrix system.

The unevenness-feeling information of an R component, a G component, and a B component, may be respectively created.

According to an aspect of the invention, there is also provided an image processing program product comprising a recording medium having recorded a program operable to cause a computer to execute the above described method.

With this configuration, it is possible to create the unevenness-feeling information which indicates the unevenness feeling of the object on the basis of the optional region in the digital image and it is possible to give the unevenness feeling to the optional region in the digital image on the basis of the created unevenness-feeling information.

According to an aspect of the invention, there is also provided an image processing device comprising:

a first setting section operable to set a reference region in a first digital image;

a calculating section operable to calculate first pixel values of pixels in the reference region and second pixel values of the pixels in the reference region on which an averaging process which substantially averages the first pixel values is performed;

a creating section operable to create unevenness-feeling information indicating an unevenness feeling of the surface of an object expressed by the reference region on the basis of the first pixel values and the second pixel values;

a second setting section operable to set a target region in a second digital image; and

a giving section operable to give the unevenness feeling to the target region on the basis of the unevenness-feeling information.

With this configuration, it is possible to create the unevenness-feeling information which indicates the unevenness feeling of the object on the basis of the optional region in the digital image, and additionally it is possible to give the unevenness feeling to the optional region in the digital image on the basis of the created unevenness-feeling information.

A respective function of plural sections provided for the invention is implemented by a hardware resource of which the function is specified by a configuration itself, a hardware resource of which the function is specified by the program and a combination of them. Additionally, the respective function of these plural sections is not limited to that each of hardware resources is physically independent of each other so as to be implemented. In addition, a sequence of the respective operation of the method described above is not limited to a sequence of the description as far as it does not have a disincentive technically, and may be operated in any sequence or at the same time.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a data flowchart illustrating an image processing program according to an embodiment of the invention;

FIG. 2 is a block diagram illustrating an image processing device according to the embodiment of the invention;

FIG. 3(A) is a graph illustrating pixel values of a digital image according to the embodiment of the invention, FIG. 3(B) is a graph illustrating pixel values after an averaging process is performed on the digital image, and FIG. 3(C) is a schematic diagram illustrating unevenness-feeling information according to the embodiment of the invention;

FIG. 4 is a schematic diagram illustrating a digital image according to the embodiment of the invention;

FIG. 5 is a schematic diagram illustrating a reference region and a target region according to the embodiment of the invention;

FIGS. 6(A) and 6(B) are graphs illustrating a synthesis ratio according to the embodiment of the invention;

FIGS. 7(A) and 7(B) are flowcharts illustrating the synthesis ratio according to the embodiment of the invention.

### DETAILED DESCRIPTION OF THE EMBODIMENTS

Hereinafter, embodiments of the invention will be described.

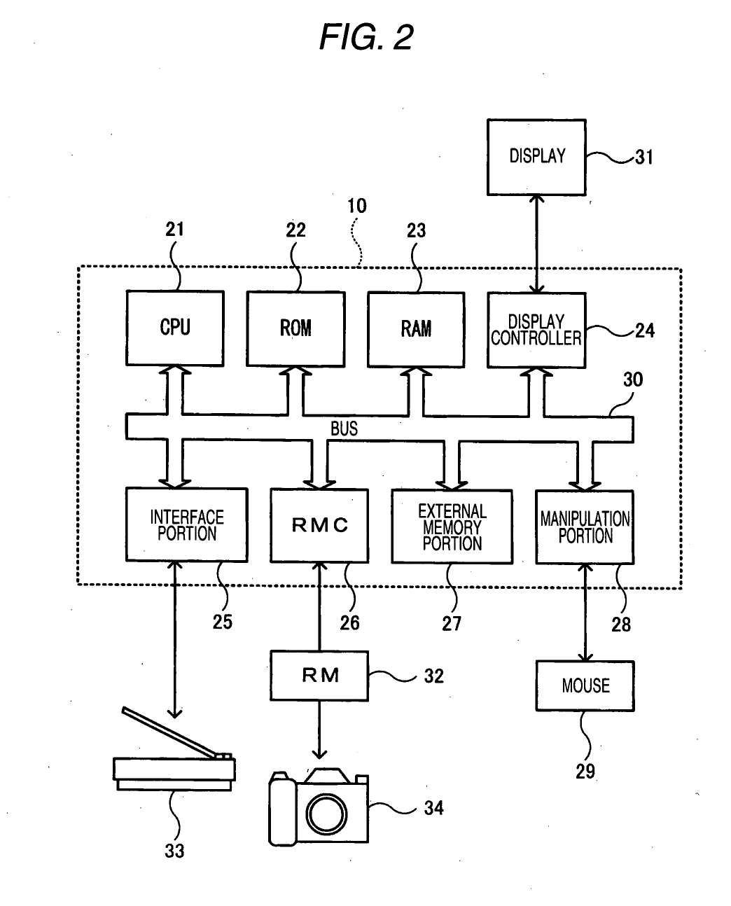

FIG. 2 is a block diagram illustrating a hardware configuration of a personal computer (PC) 10 functioning as an image processing device according to the embodiment of the invention.

A CPU 21 controls the overall PC 10 by executing a program which is memorized in a ROM 22 or an external memory unit 27. The ROM 22 is a memory which memorizes various programs or data in advance and the RAM 23 is a memory which memorizes temporarily the various programs or the data.

A display controller 24 is controlled by the CPU 21 and displays a digital image via a display 31 such as a CRT (a Cathode Ray Tube), a LCD (a Liquid Crystal Display), and a FPD (a Flat Panel Display).

An interface unit 25 includes a USB controller, a USB connector, and the like so as to communicate with an external system such as an image scanner 33. A transmission standard is not limited to the USB, and may be any standard such as an IEEE 1394, an infrared, an Ethernet®. For example, the digital image which is created by reading a picture sheet indicating an object picture via the image scanner 33 is inputted into the PC 10 through the interface unit 25.

A removable memory controller (RMC) 26 connects with a removable memory (RM) 32 via a connector (not shown in the drawings) and controls a data transfer between the removable memory 32 and the RAM 23. The removable memory 32 may be a card-type flash memory, that is, a memory card, and another nonvolatile memory medium which can repeatedly write. For example, a created digital image of which an object is taken by a digital still camera (DSC) 34 is inputted into the PC 10 via the removable memory 32.

The external memory unit 27 includes a hard disk, a hard disk controller, or the like and an operating system (OS), the image processing program, and other various programs, data or the like is memorized therein. These programs or various data may be downloaded from a predetermined server via a network so as to input and may be readout from a memory medium of which a computer such as the removable memory 32 is able to read.

A manipulation unit 28 includes a keyboard controller to which a keyboard (not shown in the drawings) connects, a mouse controller to which a mouse 29 connects, or the like.

In the next, unevenness-feeling information will be described.

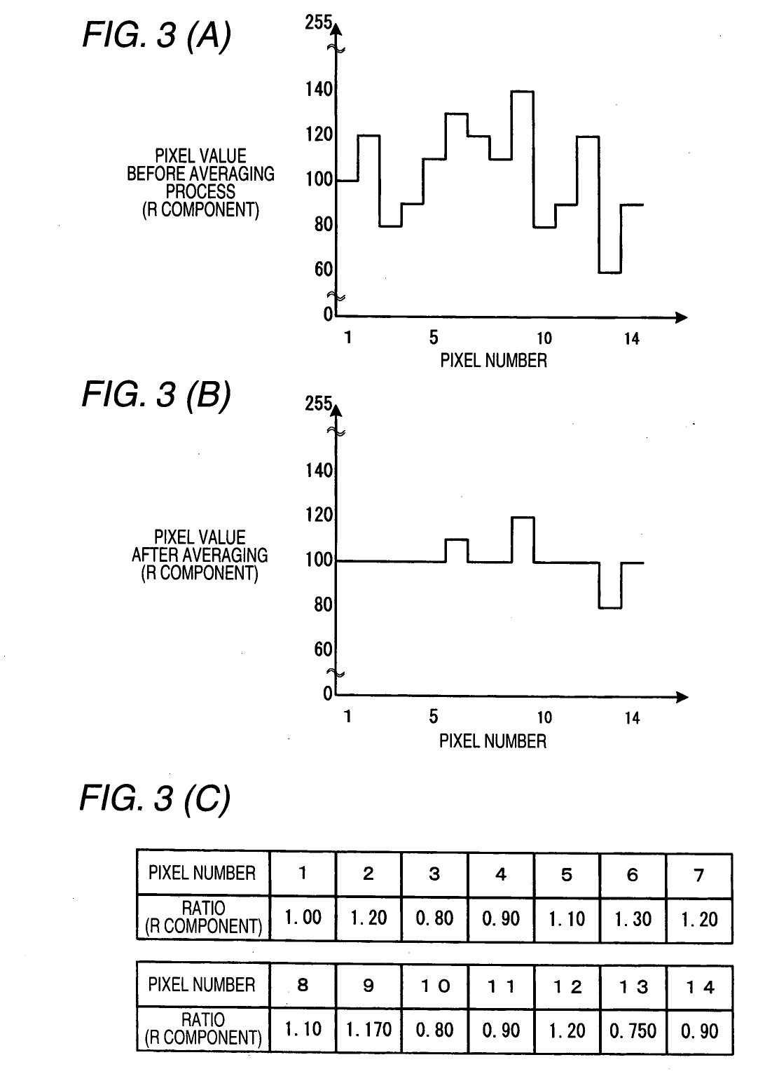

FIG. 3(A) is a graph illustrating an R-component pixel value of each pixel of a region denoting an object in the digital image when it is arranged in a predetermined sequence. The predetermined sequence denotes, for example, a sequence from upper rows to lower rows and a sequence from the left pixel to the right pixel with respect to each row. Generally, when a person sees an object, the person recognizes a material feeling of the object on the basis of the unevenness feeling of a surface. For instance, when the object has a specific unevenness feeling of a wood, the person feels the material feeling of the wood of the object. Similarly, when the object has a specific unevenness feeling of a cloth, the person feels the material feeling of the clothes of the object. When a graph of which the R-component pixel values of pixels are arranged is created, an undulation corresponding to the unevenness feeling of the surface of the object occurs in the graph. Accordingly, the undulation occurring in the graph denotes the unevenness feeling of the surface of the object. In other words, the graph denotes the material feeling of the object. Although the R component is described herein, a green component (a G component) and a blue component (a B component) are in the same way as the above-description.

FIG. 3(B) is a graph of which an averaging process for substantially averaging the pixel values is performed on the above-described region and then the R-component pixel values of the pixels after the averaging process is performed are arranged in the same sequence. Herein, averaging the pixel values means minimizing a standard deviation of the pixel values. In general, when the averaging process is performed, the undulation of the graph decreases to be a flat shape as shown in the graph. That is to say, when the averaging process is performed, the unevenness feeling of the object is impaired in the digital image.

FIG. 3(C) indicates a ratio which is acquired by dividing the R-component value before the averaging process is performed on the respective pixel of the above-described respective region by the corresponding R-component value after the averaging process is performed. For instance, when the R-component value is ‘140’ before performing the averaging process of a certain pixel and the R-component value is ‘120’ after performing the averaging process of that, a ratio is ‘1.170’. In the embodiment, that the obtained ratio with respect to each of the pixels is arranged in accordance with the above-described sequence is called the unevenness-feeling information. The unevenness-feeling information may be a value which is obtained by deducting the corresponded R-component value after performing the averaging process from the R-component value before performing the averaging process.

Next, a dust removing program functioning as the image processing program will be described.

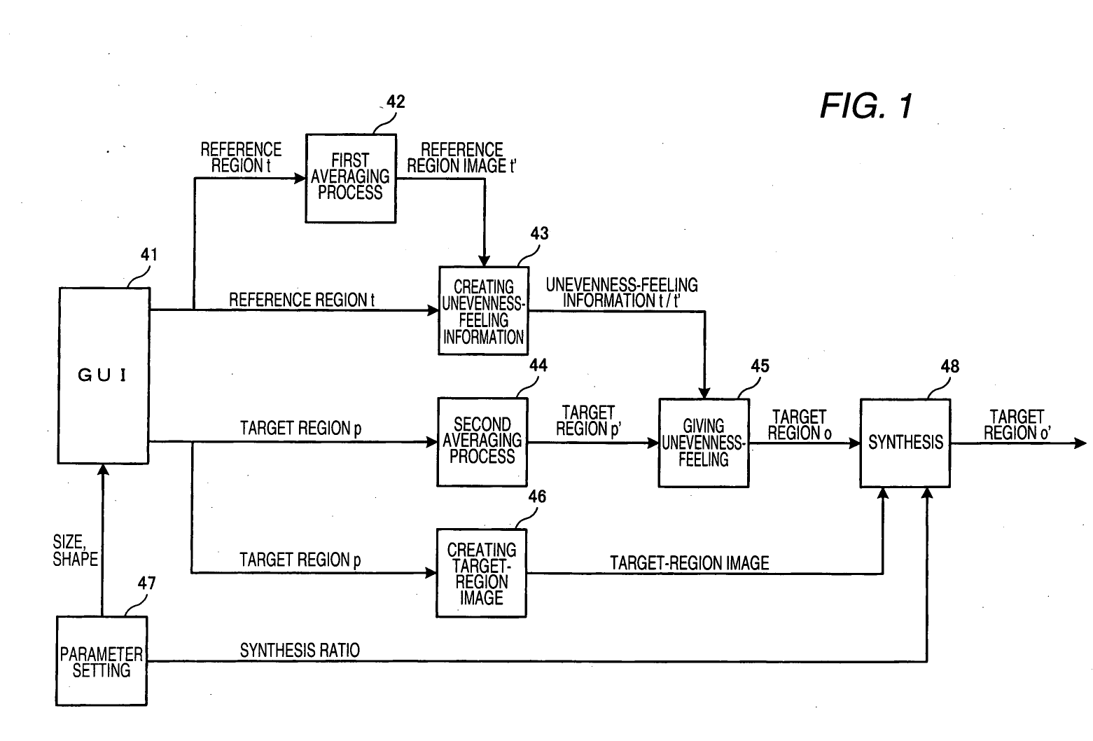

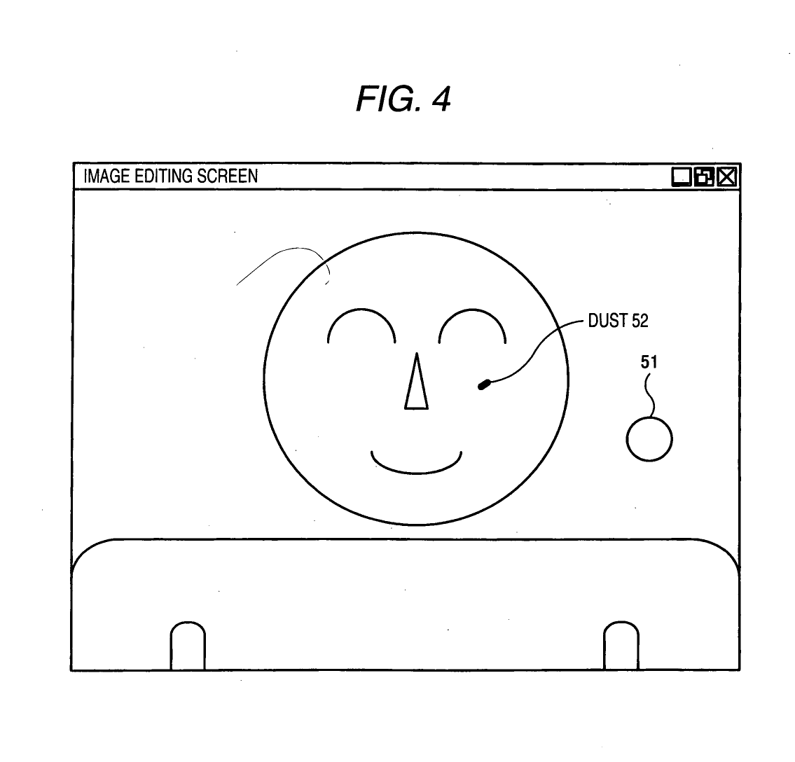

FIG. 1 is a flowchart illustrating a data of the dust removing program and FIG. 4 is a schematic diagram illustrating an example of the digital image. Each of processes shown in FIG. 1 is executed by the CPU 21 which executes the dust removing program.

A GUI (a Graphical User Interface) process 41 is a process which provides a GUI for setting a reference region in a first digital image and a GUI for setting a target region in a second digital image. The first digital image and the second digital image may be the same digital image with each other. In the embodiment, it will be described in the case where the first digital image and the second digital image have the same digital image with each other. The GUI process 41 indicates a round-shaped mouse pointer 51 in the digital image as shown in FIG. 4. The round-shaped mouse pointer 51 is used as a dust removing brush. A size or a shape of the displayed dust removing brush 51 is determined by a radius or a shape which is set by a parameter setting process 47. Hereinafter, a setting of the reference region and the target region will be described.

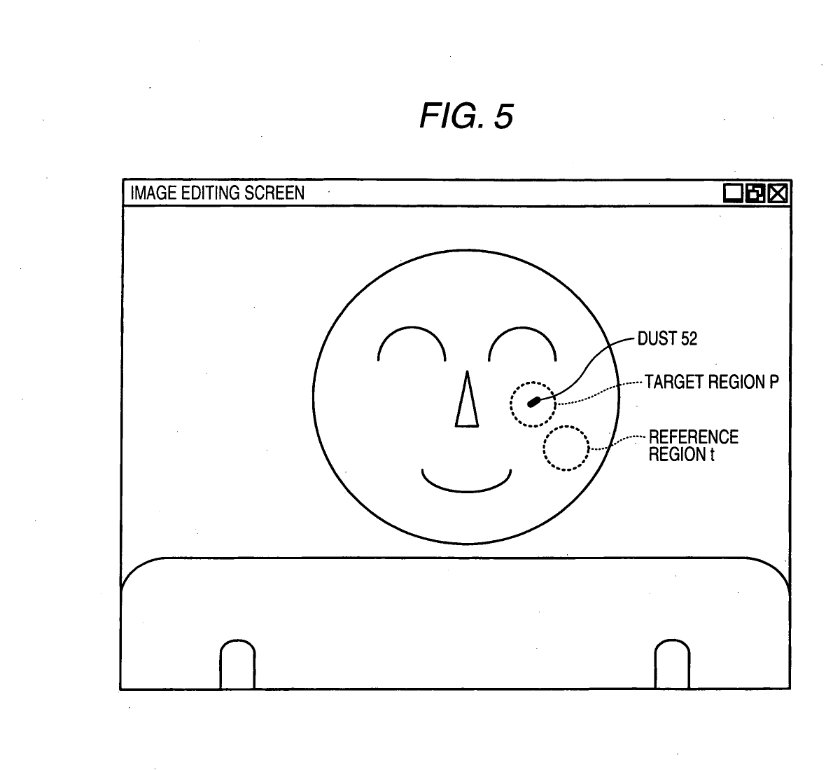

A setting of a reference region t is performed by moving the dust removing brush 51 in the digital image by means of manipulating the mouse, and clicking a left button of the mouse 29 at a moved position. When a user clicks the left button of the mouse 29, a round-shaped region which is overlapping with the dust removing brush 51 is set to be the reference region t in the digital image as shown in FIG. 5.

A setting of a target region p is performed by a manipulation scraping the dust removing brush 51 on the dust 52 with the left button of the mouse 29 pushed. After the reference region t is set, the user moves the dust removing brush 51 onto the dust 52 by manipulating the mouse. When the left button of the mouse 29 is clicked at a moved position, a region overlapping with the dust removing brush 51 in the digital image is set to be the target region p as shown in FIG. 5. The target region p may overlap with a portion of the reference region t.

When the user moves the mouse 29 with the left button of the mouse 29 is clicked, the dust removing brush 51 moves together with that. Whenever the dust removing brush 51 moves by a predetermined distance, a region after moving is reset as the target region p. The predetermined distance is specifically, for example, a radius of the dust removing brush 51.

A first averaging process 42 is a process which calculates the pixel values of the reference region t when the averaging process for substantially averaging the pixel values is performed on the reference region t. The fist averaging process 42 creates a reference-region image cloned the reference region t by copying the set reference region t onto the RAM 23, and the averaging process is performed by giving a Gaussian filter to the reference-region image on the RAM 23. In the following description, the reference-region image on which the averaging process is performed will be referred to as a reference-region image t′. The Gaussian filter is a spatial filter which chooses a weighted average allowing a pixel close to a interested pixel to have a large weight and a pixel far from an object pixel to have a small weight in order to a weighted average value is set to the interested pixel. The Gaussian filter is a method which is well known for an averaging filter so that may remove a noise of the image.

The averaging process method is adequately selectable design details, and some other method such as a median filter which selects an intermediate value of peripheral 8 pixel values may be performed except for giving the Gaussian filter. Additionally, the averaging process method for the reference region and the target region may select a different method, respectively. In addition, any averaging process is not performed on actual, but a mean value or an intermediate value constituting the reference region t is acquired, the pixel values of the pixels when the averaging process is performed on the mean value or the intermediate value which is acquired is performed may be used as a whole. The mean value or the intermediate value can be acquired without performing the averaging process on the reference-region image, so in that case, the reference-region image needs not creating.

An unevenness-feeling information creating process 43 is a process which creates unevenness-feeling information t/t′ on the basis of the reference region t and the reference-region image t′. The unevenness-feeling information creating process 43 creates the respective unevenness-feeling information of the R component, G component, and B component by dividing the R component, G component, and B component constituting the reference region t by the corresponding R component, G component, and B component of the reference-region image t′. In the embodiment, unevenness-feeling information of the R component is expressed by R/R′, unevenness-feeling information of the G component is expressed by G/G′, unevenness-feeling information of the B component is expressed by B/B′, and the unevenness-feeling information of them is expressed by t/t′ in total.

A target-region image creating process 46 is a process which creates a target-region image cloned the target region p by copying the target region p before performing the averaging process on the RAM 23.

A second averaging process 44 is a process which performs the averaging process by directly giving the Gaussian filter to the target region p in the digital image. The target region p after performing the averaging process will be referred to as a target region p′. When the Gaussian filter is applied, the target region p is made to be so blur that the dust 52 disappears. However, as described above, the undulation of the graph becomes small to be a flat shape, and thus the unevenness feeling is impaired. The averaging process method is adequately selectable design details as described above.

An unevenness-feeling giving process 45 is a process which gives the unevenness feeling to the target region p′ by using the unevenness-feeling information t/t′. When the target region p′ after giving the unevenness feeling is expressed by o, giving the unevenness feeling can be expressed by the following expression 1.

O=t/t′·p′ Expression 1

The expression 1 indicates schematically giving the unevenness feeling, and at the time of a calculation in real, the R component, the G component, and the B component of the respective pixel constituting the target region p′ is multiplied by a corresponding ratio of the unevenness-feeling information R/R′, the unevenness-feeling information G/G′, and the unevenness-feeling information B/B′, respectively. When the unevenness-feeling information is multiplied, the graph of a color element of the pixel constituting the target region p′ can be allowed to have the same undulation before performing the averaging process. In other words, it is possible to give the substantially original unevenness feeling to the target region p′.

The unevenness-feeling information t/t′ is what to give not color of the reference region t but the unevenness feeling of the reference region t to the target region p′. Because of this, color of the target region p′ does not have a big difference even when the unevenness feeling is given by using the unevenness-feeling information t/t′. Accordingly, it is possible to give the unevenness feeling to the target region p′ without largely changing the color.

However, when the unevenness-feeling information t/t′ is created on the basis of the reference region t, the unevenness feeling of not the target region p but the reference region t is given to the target region p′, and thus the unevenness feeling of the target region p′ does not completely recover the original unevenness feeling (the unevenness feeling of the target region p). However, when the target region p and the reference region t are set to be within the range which indicates the same object in the digital image, the person does not feel any incompatibility about the unevenness feeling when seeing it, or a degree sensing any incompatibility about the unevenness feeling is pretty small.

In the case where a difference which subtracts the pixel value before performing the averaging process from the corresponding pixel value after performing the averaging process uses as a the unevenness-feeling information, the corresponding difference of the unevenness-feeling information may be added to the respective pixel of the target region p′. In this case, a gain value is specified for the user, and the respective difference may be adjusted and added on the basis of the gain value specified by the user.

In addition, in the embodiment, the case where the reference region t and the target region p are the same size and shape is described as an example, but the reference region t and the target region p may not have the same size and shape. For instance, a rectangular-shaped region smaller than the target region p is set as the reference region t, and the created unevenness-feeling information t/t′ may be cloned and used by connecting them with each other.

A synthesis process 48 is a process which allows the target-region image to synthesize the target region o with a predetermined synthesis ratio. The synthesis process 48 allows the target region o and the target-region image to be synthesized with each other on the basis of a synthesis ratio of the respective pixel determined by the use of the parameters and locations set by the parameter setting process 47. For example, when a synthesis ratio of the pixel disposed in a certain location is 20%, the synthesis process 48 synthesize them as the pixel value of the pixel disposed in the certain location of the target region o is 20% and the pixel value of the pixel disposed in the certain location of the target-region image is 80%, and then the synthesized pixel value will be referred to as a pixel value disposed in the certain location of the target region o′ after the synthesis.

A parameter setting process 47 is a process which sets various parameters such as a radius, strength, and a position of the dust removing brush 51.

The radius of the dust removing brush 51 is a parameter which determines a size of the dust removing brush 51. In other words, it is a parameter to determine a size of the target region p. The parameter setting process 47 specifies the radius by the pixel unit for the user by indicating a setting screen (not shown in the drawings) to set the radius of the dust removing brush 51 to the display 31. The user can change adequately the size of the dust removing brush 51 in accordance with the size of the dust by setting the radius of the dust removing brush 51.

Herein, although the parameter which determines the size of the dust removing brush 51, a shape of the dust removing brush 51, that is, a parameter for determining a shape of the target region p may be additionally set. For example, a parameter allowing the round-shaped dust removing brush 51 to be an oval and a parameter allowing a rotation angular range of the oval dust removing brush 51 to be determined may be set. The user can adequately change the shape or the angular range of the dust removing brush 51 in accordance with the shape of the dust 52 by setting the shape or the angular range of the dust removing brush 51.

The strength and the position is a parameter which determines the synthesis ratio for allowing the target-region image to synthesize the target region p′.

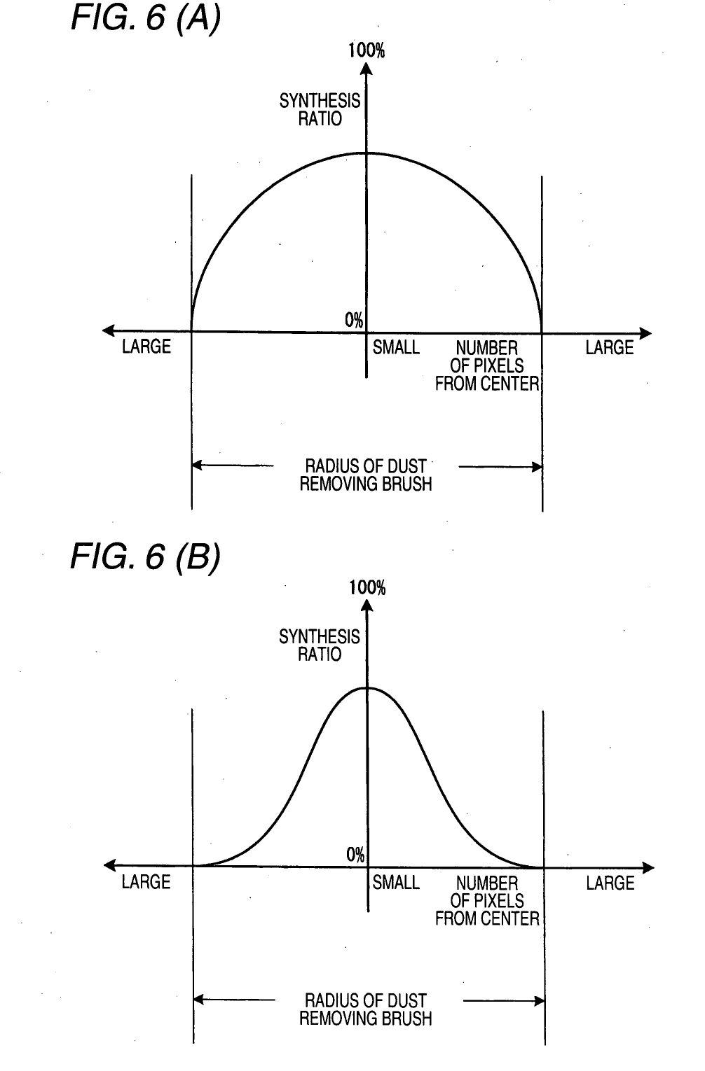

FIGS. 6(A) and 6(B) are a graph illustrating the strength and the position. A horizontal axis of the graph indicates a distance from the center of the dust removing brush 51 as the number of pixels, and a vertical axis indicates a percentage indicating a ratio (the synthesis ratio) which the pixel value of the target region o occupies in the target region o′ after the synthesis.

The strength is a parameter which determines a maximum value of the synthesis ratio, and the graph grows higher as the strength grows larger. The parameter setting process 47 specifies the strength in the range of 0% to 100% for the user by displaying a setting screen (not shown in the drawings) for specifying the strength in the display 31.

The position is a parameter which determines a shape of the graph, and when the position is large, the shape of the graph becomes a substantially semicircular shape as shown in FIG. 6(A), and on the contrary when the position is small, the shape of the graph becomes a shape such as a normal distribution as shown in FIG. 6(B). The parameter setting process 47 specifies the position for the user by displaying the setting screen (not shown in the drawings) for specifying the position onto the display 31.

As shown in FIGS. 6(A) and 6(B), in the synthesis ratio, the ratio of the target region o becomes smaller as the pixel becomes distant from the center of the dust removing brush 51, and on the contrary, the ratio of the target region o becomes larger as the pixel becomes close to the center thereof. When the synthesis ratio is set in this way, the unevenness feeling of the target region o′ and the unevenness feeling of peripheral region can be connected to be smooth. According to this, it is possible to reduce an unnatural look of a variation of the unevenness feeling of a boundary between the target region o′ and the peripheral region when the person recognizes by seeing them.

In the next, it will be described a procedure that the PC 10 executes the dust removing program.

Herein, as an example in the case where the dust 52 in the digital image as shown in FIG. 4 is removed, the procedure of the PC 10 executing the dust removing program will be described at every single manipulation. In following manipulations, the user sets a region in which the dust 52 of a face is not included as the reference region t, and the user sets a region in which the dust 52 of the face is included as the target region p as shown in FIG. 5.

(1) In the case where a manipulation for setting the reference region is executed.

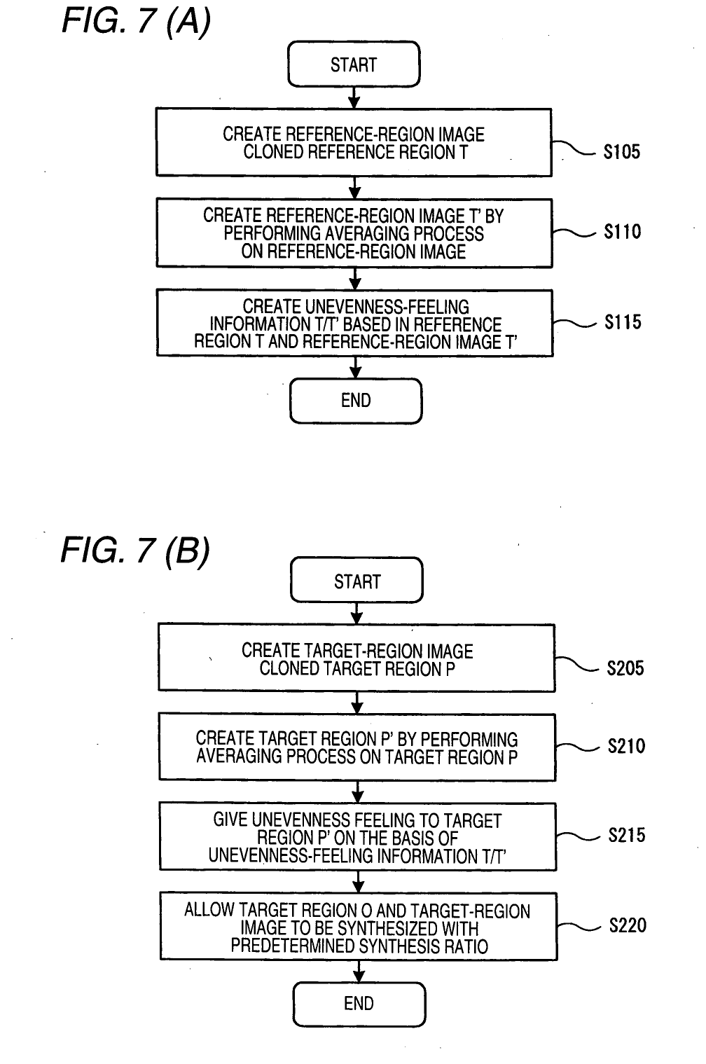

FIG. 7(A) is a flowchart illustrating a sequence of a process when the manipulation for setting the reference region is executed.

In S105, the CPU 21 creates the reference-region image which cloned the reference region t by copying the set reference region t to the RAM 23.

In S110, the CPU 21 creates the reference-region image t′ by performing the averaging process on the reference-region image.

In S115, the CPU 21 creates the unevenness-feeling information t/t′ on the basis of the reference region t and the reference-region image t′, and memorizes the created unevenness-feeling information t/t′ in the RAM 23.

(2) After the reference region t is set, when a manipulation for setting the target region p is executed.

FIG. 7(B) is a flowchart illustrating a sequence of a process when the manipulation for setting the target region p.

In S205, the CPU 21 creates the target-region image which cloned the target region p by copying the set target region p to the RAM 23.

In S210, the CPU 21 creates the target region p′ by directly performing the averaging process on the target region p in the digital image.

In S215, the CPU 21 reads the unevenness-feeling information t/t′ from the RAM 23, and gives the unevenness feeling to the target region p′ on the basis of the unevenness-feeling information t/t′.

In S220, the CPU 21 allows the target region p′ after the unevenness feeling is given, that is, the target region o and the target-region image to be synthesized with each other with the specific synthesis ratio of the respective pixel on the basis of the set parameter and the pixel location.

(3) After the manipulation for setting the target region p is executed, when the dust removing brush 51 is moved with a predetermined distance by performing a manipulation for moving the mouse 29 with the left button of the mouse 29 clicked.

A process in this case is the same as that of ‘(2)’. That is, the process of ‘(2)’ is performed whenever the dust removing brush moves as long as a predetermined distance with the left button of the mouse 29 clicked. Namely, the user can allow the dust to be gradually blurred by a manipulation for scraping the dust 52 with the dust removing brush 51 with the left button of the mouse 29 clicked.

According to the PC 10 of the invention as described above, since it is possible to set a random region in the digital image as the reference region t, the unevenness-feeling information t/t′ indicating the unevenness feeling of a face can be created on the basis of the region displaying the face in the digital image. In addition, according to the invention, since it is possible to set a random region in the digital image as the target region p, it is possible to give the unevenness feeling to a region of the face to which the averaging process is performed on the basis of the unevenness-feeling information t/t′ by setting a region of the face to which the averaging process is performed as the target region p.

In addition, according to the PC 10, it is possible to allow the dust in the digital image to be invisible by setting a region in which the dust is included in the digital image as the target region p and performing the averaging process on the target region p. By performing the averaging process, the unevenness feeling of the face of which the target region p indicates is impaired, but by the use of setting the reference region t in the range of the face of the same person, creating the unevenness-feeling information t/t′, and giving the unevenness feeling to the target region p on the basis of the unevenness-feeling information t/t′, it is possible to give the substantially original unevenness feeling to the region of the face to which the averaging process is performed. That is, according to the PC 10, it is possible to remove the dust without impairing the unevenness feeling of the face.

The invention is not limited to the embodiment, and may be modified to various forms of the embodiments within the object of the invention, if necessary.

What is claimed is:

1. An image processing method comprising:
setting a reference region in a first digital image;
calculating first pixel values of pixels in the reference region and second pixel values of the pixels in the reference region on which an averaging process which substantially averages the first pixel values in performed;
creating unevenness-feeling information indicating the unevenness feeling of the surface of an object expressed by the reference region on the basis of the first pixel values and the second pixel values;
setting a target region in a second digital image; and
giving the unevenness feeling to the target region on the basis of the unevenness-feeling information.

2. The image processing method according to claim 1, further comprising:
performing the averaging process on the target region,
wherein the unevenness feeling is given to the target region on which the averaging process is performed.

3. The image processing method according to claim 1, wherein the averaging process makes a digital image blurred.

4. The image processing method according to claim 1, wherein:
wherein the unevenness-feeling information is a set of ratios which are obtained by dividing each of the first pixel values of the pixels by each of the second pixel values of the corresponding pixels; and
wherein the unevenness feeling is given by multiplying third pixel values of pixels in the target region by the ratios.

5. The image processing method according to claim 1, further comprising:
setting a size or a shape of the target region.

6. The image processing method according to claim 1, further comprising:
replicating the target region to create a target-region image; and
synthesizing the target-region image with the target region to which the unevenness feeling is given at a predetermined synthesis ratio.

7. The image processing method according to claim 1, wherein:
the target region has a shape which can specify a center;
the synthesis ratio indicates in the unit of pixels a ratio of the target region to which the unevenness feeling is given; and
the ratio becomes lower as a pixel becomes more distant from the center of the target region.

8. The image processing method according to claim 6, further comprising:
setting the synthesis ratio.

9. The image processing method according to claim 1, wherein the first digital image and the second digital image are the same digital image as each other.

10. The image processing device according to claim 1,
wherein the first digital image and the second digital image are a digital image which is expressed by an RGB color matrix system; and
wherein the unevenness-feeling information of an R component, a G component, and a B component, are respectively created.

11. An image processing program product comprising a recording medium having recorded a program operable to cause a computer to execute the method according to claim 1.

12. An image processing device comprising:
a first setting section operable to set a reference region in a first digital image;
a calculating section operable to calculate first pixel values of pixels in the reference region and second pixel values of the pixels in the reference region on which an averaging process which substantially averages the first pixel values is performed;
a creating section operable to create unevenness-feeling information indicating an unevenness feeling of the surface of an object expressed by the reference region on the basis of the first pixel values and the second pixel values;
a second setting section operable to set a target region in a second digital image; and
a giving section operable to give the unevenness feeling to the target region on the basis of the unevenness-feeling information.
